(19) United States
(12) Patent Application Publication
(10) Pub. No.: US 2012/0308274 A1
(43) Pub. Date: Dec. 6, 2012

(54) SINGLE BTR ROLL AT STRIPPER FOR CONTINUOUS WEB TRANSFER

(75) Inventors: Roger G. Leighton, Rochester, NY (US); Christopher A. DiRubio, Webster, NY (US)

(73) Assignee: XEROX CORPORATION, Norwalk, CT (US)

(21) Appl. No.: 13/152,555

(22) Filed: Jun. 3, 2011

(51) Int. Cl. G03G 15/16

(52) U.S. Cl. 399/317

(57) ABSTRACT

An electrostatographic printing apparatus that includes a charge receptor endless belt; a transfer nip including a BTR roll in contact with the charge receptor at a transfer zone, a continuous media supplied to the transfer zone, and the transfer nip adapted for systematic engagement and disengagement with the continuous media for synchronization of image transfer from the charge receptor to the media. More specifically, in response to recognition of imaging inconsistencies such as belt seams, test patches, or label format pitches, the endless belt disengages from the continuous media at the BTR roll. The BTR roll is appropriately turned on and off and the continuous media reversed in direction commonly known as a ‘Pilgrim step’, then returned to normal direction to synchronize the transfer of images to the continuous media.

### BACKGROUND

1. Field of the Disclosure

This disclosed device and method relates generally to a transfer station used in electrostatographic or xerographic printing.

2. Description of Related Art

The basic process steps of electrostatographic printing, such as xerography or iconography include creating an image with the toner particles which is transferred to a print medium, which is typically a sheet of paper but which could conceivably be any kind of substrate, including an intermediate transfer belt or continuous web. This transfer is typically carried out by the creation of a “transfer zone” of electric fields where the print sheet is in contact with, or otherwise proximate to, the photoreceptor. Devices to create this transfer zone are well known in the prior art.

For example, the use of BTR (Biased Transfer Roll) foam rollers to either pull an image from a PR belt or drum to an intermediate belt or from an intermediate belt to paper are often used. Typically, in such transfer operations, as shown in U.S. Pat. Nos. 7,242,894 and 7,158,746, a biased transfer roll is disposed in contact with a portion of a photoreceptor, thus forming an image transfer nip. An image-receiving sheet passes through the nip between the photoreceptor and transfer roll. At the nip itself, a toner image on the photoreceptor is transferred to the sheet by a combination of physical pressure at the nip, caused at least in part by the transfer roll, and an electrical bias placed on the transfer roll by suitable circuitry.

In web feeding, however, instead of feeding pre-cut sheets to be printed, the image substrate material is typically fed from large rolls of paper in a defined width. A difficulty, however, in printing from an endless belt type photoreceptor printing engine onto a continuous web substrate is the fact that belt type photoreceptors typically have a belt seam where the two ends of the belt are fastened to one another to form a continuous loop. Typically it is either impossible or undesirable to form images overlying this belt seam, resulting in asynchronous or irregularly spaced image production. This, in general, can be a significant problem to the transfer of those images to a substrate. The problem is more severe, in particular, in the synchronization of images with a continuous web substrate.

Heretofore, it has been difficult or impractical to rapidly start and stop paper webs running through a printing system at high speeds because of the danger of web tearing, slippage, or misregistration, and/or the large moment and mass of the paper roll. As disclosed in U.S. Pat. No. 5,970,304, buffer loops and dancer rolls are known for the buffering of web speed variations and also the separation of the web from the nip to adjust the relationship of the photoreceptor belt and web for facilitating the transfer of images from the belt to the web.

However, if the paper or substrate being fed is not a cut sheet, but rather a continuous roll of sheet paper or label media, the standard transfer process is inadequate. The conversion of a high speed, high volume Xerographic machine with a cut sheet paper supply to a continuous paper roll feed for label or book production requires an entirely new transfer area, that will not disturb the unfused toner either by lateral or process direction shear forces resulting from velocity mis-matches or from air breakdown while the media makes contact to the belt. Various events must be considered such as the skipping of the photoreceptor (PR) belt seam and skipping various other images on the belt such as test patches, in order that the pitch to pitch distance of images transferred to the paper and paper roll feed is held consistent. The new system must also be configured such that air break down does not occur disturbing the image by reducing the nip area, pre-wrapping the PR assist roll, and sufficient attack exit angle.

It would also be desirable to provide other possible advantages to prior continuous paper feed systems such as better registration error control, and a smaller transfer nip. For example, a BTR transfer zone is typically only 3-5 mm, which makes it easier to insure good image quality and low shear area due to either web velocity mis-match errors or lateral position error moments. Also, it may be desirable to fully strip the web with the image prior to the seam before disengaging the web from the photoreceptor.

### SUMMARY OF THE DISCLOSURE

Thus, in order to maintain the continuous paper web feed pitch and compensate for occurrences such as the need to avoid the seam on the PR belt, a BTR roll is provided at the transfer zone or station and the paper web separated from the BTR nip. The continuous paper web is driven backwards and then accelerated to position the paper web at exactly the correct location prior to the paper web and PR belt uniting at the BTR roll nip. This is known as a ‘Pilgrim step’ in the converting industry.

In operation, according to the disclosure, a suitable BTR roll, often a soft foam roll, when engaged with an auxiliary or stripper roll will produce a nip of 3-5 mm wide for generating a transfer field and depositing a positive tacking charge to the backside of the paper. The toner is negative and is drawn to the paper from the photoreceptor belt. The coordination of web tension, auxiliary roll, and BTR roll will provide controllable belt engagement and defined timing of transfer of image without destructive uncontrolled air breakdown to the image. The timing of the auxiliary roll and BTR roll engagement after reversing will allow for synchronization of the turn on of the field in the gap between images without creating toner disturbances.

### BRIEF DESCRIPTION OF THE DRAWINGS

Various of the above-mentioned and further features and advantages will be apparent to those skilled in the art from the specific apparatus and its operation or methods described in the example(s) below, and in the claims. Thus, they will be better understood from this description of these specific embodiment(s), including the drawing figures (which are approximately to scale) wherein:

FIG. 1 illustrates a belt seam (or test patch or label pitch) approaching the transfer BTR;

FIG. 2 shows the lead edge of the seam area has just passed the BTR field on the nip exit edge;

FIG. 3 is showing a wringer roll drop to increase the web wrap on the BTR as the web is decelerated which unwraps the web from the PR assist roll;

FIG. 4 illustrates the continuing wringer and BTR drop before the web is ready to be reversed, the PR belt continues to traverse the seam;

FIG. 5 illustrates web reversal;

FIG. 6 shows web acceleration and timing to reunite the image on the PR with the next pitch or proper web location;

FIG. 7 shows the wringer and BTR raised, tension reduced on the web, the trail edge of the seam passing thru the nip area with the BTR energized; and

FIG. 8 illustrates the printer resuming operation.

### DETAILED DESCRIPTION OF THE DISCLOSURE

In accordance with the disclosure, the system uses a continuous web of stock or paper instead of cut sheet media. Various process patches on the PR belt create inconsistencies with the media feed, for example, a label dimension or seam that require timing and coordination. A BTR roll provides a relatively small nip at the transfer zone or station and the paper web is separated from the BTR nip. The well defined nip edges allow for accurate timing of the registration between the PR belt and web media. The web is stopped and reversed, then reversed again to reunite with the PR belt. The timing of the BTR roll engagement after reversing will allow for synchronization of the turn on of the field in the gap between images without creating toner disturbances due to air breakdown.

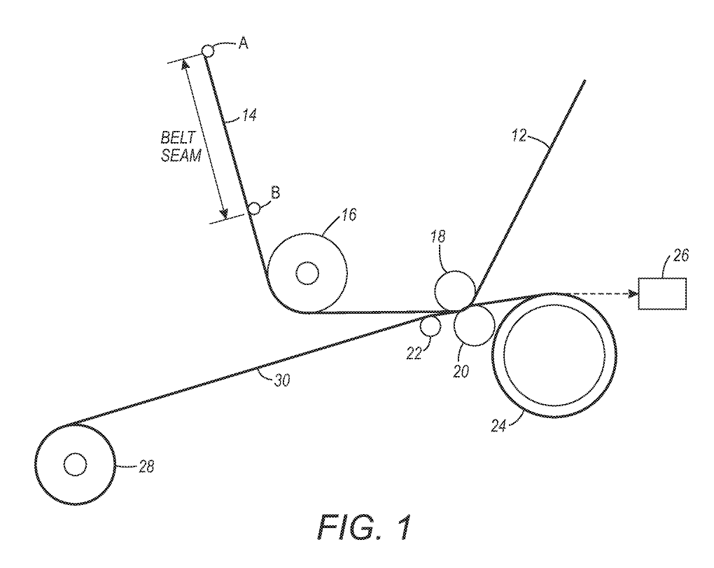

With reference to FIG. 1, There is illustrated an endless photoreceptor belt 12 as it passes through the transfer station of a high speed xerographic imaging machine. The belt is shown with a belt seam portion 14 extending between points A and B. The main drive of the belt 12 is shown at 16 driving the belt through the transfer station illustrated by auxiliary stripper roll 18, biased transfer roll (BTR) 20, and wringer roll 22. The auxiliary stripper roll 18 sets an approach angle of paper into the nip with the BTR 20.

The system, as shown in FIG. 1, is in continuous printing or imaging with nip engaged, however, a belt seam (test patch or a residual label pitch) is approaching the nip. For example, images are not projected on the seam and therefore the nip must be disengaged as the seam passes through. The belt, as shown, illustrates the nip 18, 20 of BTR and stripper drive engaged and forming a nip during normal printing, as the seam 14 approaches the main drive 16 with lead edge B followed by trail edge A.

It should be noted that, generally, a bias transfer roll is provided for establishing a directional force field capable of attracting toner particles from a photoconductive surface to a copy substrate that is subsequently transported to a fusing station. The bias transfer roll electrically attracts charged toner particles from the photoconductive surface to transfer the developed images on the photoconductive surface from the belt to the continuous web positioned in the transfer nip. The BTR roll is generally formed of an open cell foam which is electrically conductive. An electrical biasing device in the form of a constant current or voltage supply source is generally electrically coupled to the conductive core for providing the electrical bias.

Stripper roll 18 and BTR roll 20 form a nip to receive an imaging medium such as a continuous paper web 30, driven by a vacuum roll drive 24 and low lateral force or idler roll 28 conveying the continuous paper web 30 to the transfer station nip 18, 20. The low lateral force roll 28 with suitable strain gauge along with vacuum roll drive 24 provide suitable tension 1 to 1.5 pli on the continuous paper feed roll to convey the paper through the transfer nip to receive images from the belt 30.

The vacuum roll drive 24 applies suitable vacuum pressure to pull the paper against the roll and the images on the web 30 are then carried to a suitable fuser station 26. The web 30 makes contact roughly 2 mm prior to the field from the BTR 20 to prevent pre-nip breakdown. At this point, the wringer roll 22 is up and the wrap angle of the web 30 around the BTR 20 at the exit of the nip is about 1.5 degrees.

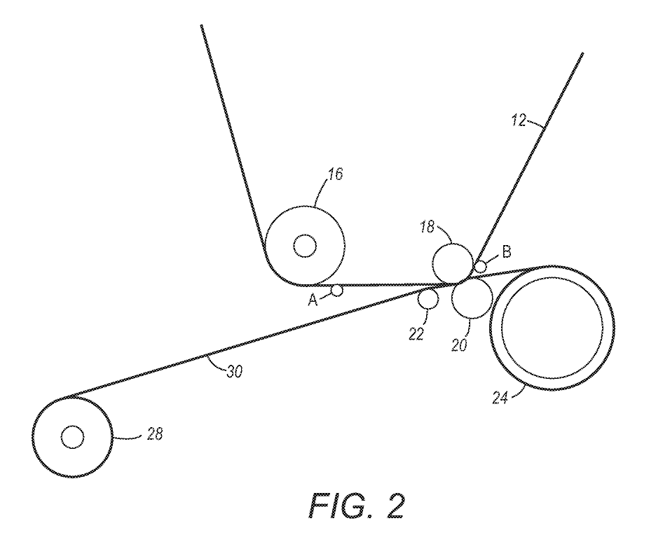

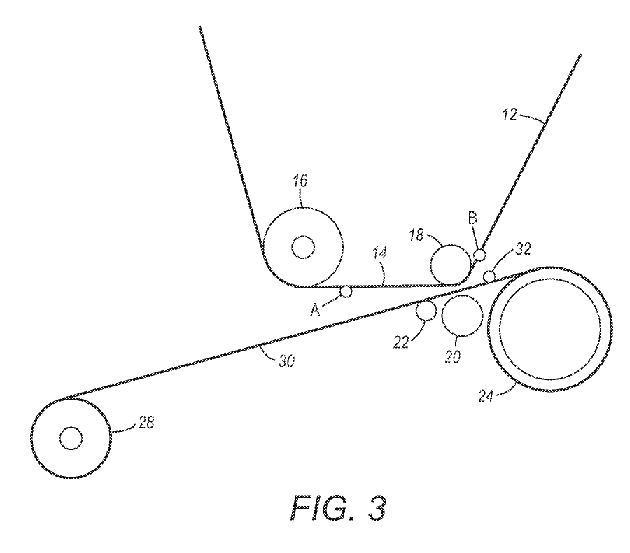

With reference to FIGS. 2 and 3, the lead edge B of the seam has just passed the BTR field at the nip exit as shown in FIG. 2. Also, as shown in FIG. 3, the BTR 20 and wringer roll 22 have been dropped away form the belt 12 to increase the wrap of the web 30 on the BTR 20. The BTR 20 is turned off and as the web 30 is decelerated, the wrap angle is about 3.0 degrees.

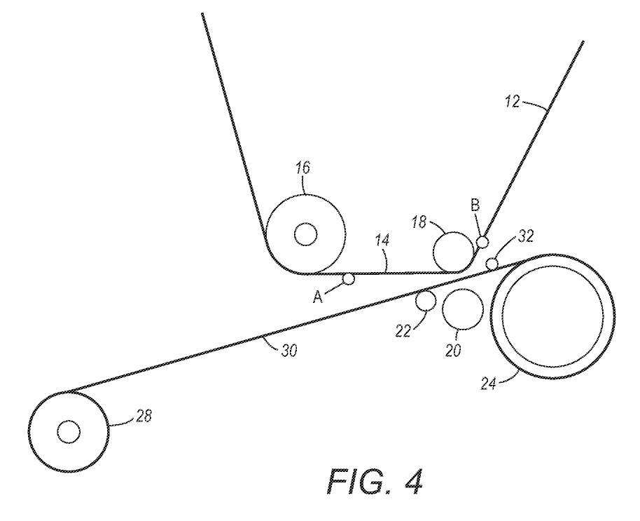

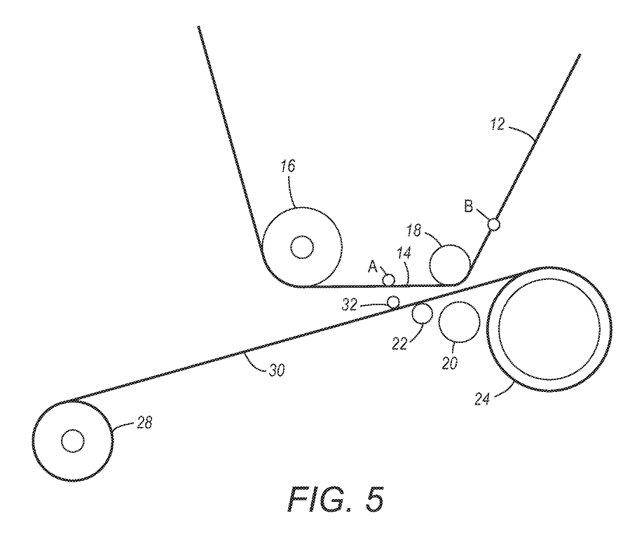

With reference to FIGS. 4 and 5, the wringer 22 and BTR 20 continue to drop away from the belt 12 as the seam 14 is passing through the nip and the direction of the web 30 is ready to be reversed. For reference, the trail edge of the last image transferred to the web 30 at the transfer station is illustrated at 32 in FIG. 4. It is then necessary to reverse the direction of the web 30 to move the trail edge to a location prior to the transfer nip. This is required in order to synchronize the placement of the first image after the seam 14 on the web 30 in suitable relationship with the last image on the web 30.

FIG. 5 illustrates the location of the trail edge 32 of the last image transferred to the web 30 at the transfer station after the web 30 direction has been reversed and the trail edge repositioned. It should be noted that the photoreceptor belt 12 continues its normal movement and the web 30 is separated from the belt 12 during this repositioning period.

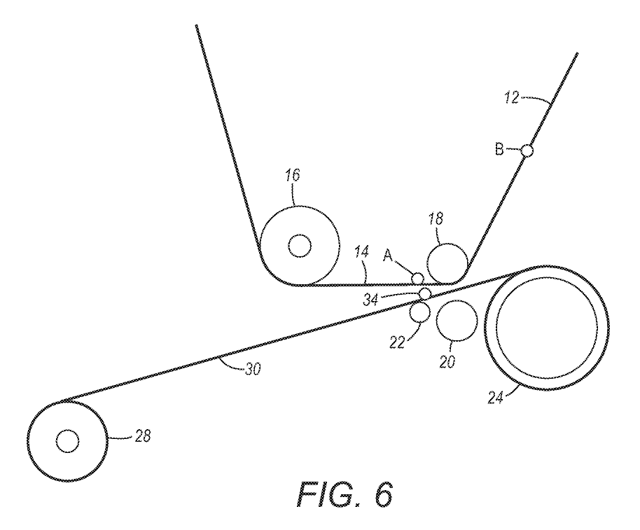

With reference to FIG. 6, the web 30 is now being accelerated forward and timed to reunite the lead edge of the next image on the belt 12 with the correct position on the web 30 in relation to the image on the web that had been reversed. That is, the next image from the belt 12 to the web 30 will have its lead edge on the web 30, illustrated at 34. However, the nip is not yet closed and the lead edge position 34 has not yet reached the transfer station nip.

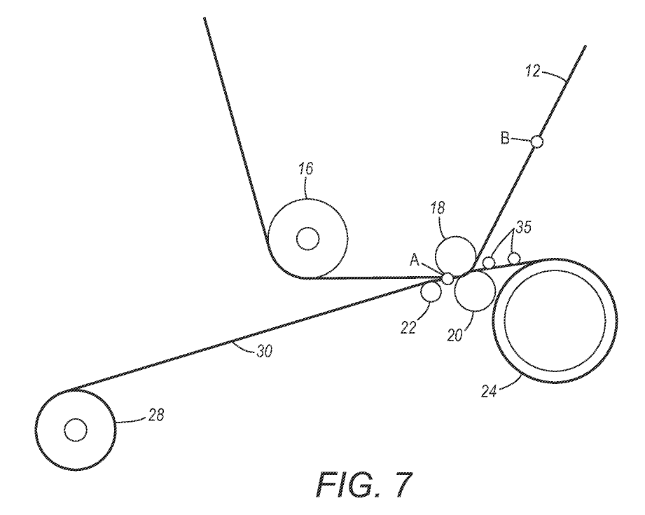

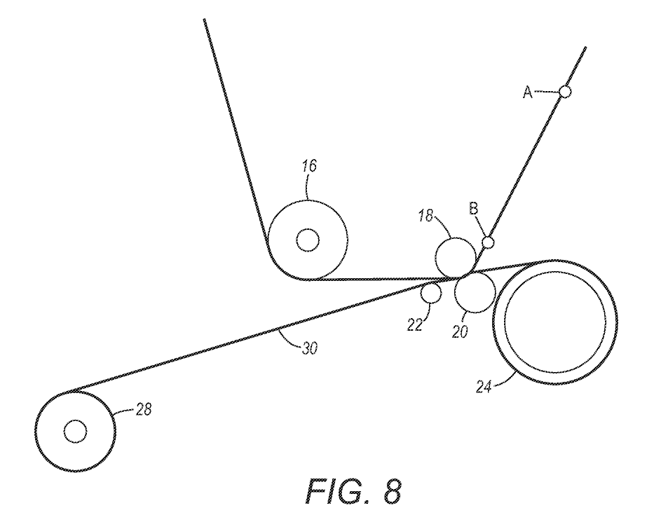

With reference to FIG. 7, the winger 22 and BTR 20 are raised and the nip 18, 20 is closed. The end of the seam passes through the nip and the BTR 20 is turned on prior to the lead edge of the next image arriving in the nip. The next image will be transferred to web 30 and to follow the previous image that had been transferred and reversed on the web, shown at 35. The web 30 again operates under the forward direction tension. FIG. 8 merely shows the resumption of normal imaging and transfer after the passage of the seam.

It should be understood that the above disclosure for the handling of a web seam is merely exemplary of different situations such as avoiding test patches and different formats for label printing and the disclosure is intended to cover a wide range of applications and teachings dealing with continuous web printing and adjustment for situations requiring a deviation from routine operation.

The claims, as originally presented and as they may be amended, encompass variations, alternatives, modifications, improvements, equivalents, and substantial equivalents of the embodiments and teachings disclosed herein, including those that are presently unforeseen or unappreciated, and that, for example, may arise from applicants/patentees and others. Unless specifically recited in a claim, steps or components of claims should not be implied or imported from the specification or any other claims as to any particular order, number, position, size, shape, angle, color, or material.

What is claimed is:

1. An electrostatographic printing apparatus, comprising: a charge receptor including an endless belt; a transfer nip including a BTR roll, in contact with the charge receptor at a transfer zone, a continuous media supplied to the transfer zone, the transfer nip adapted for systematic engagement and disengagement with the media in the transfer nip for synchronization of image transfer from the charge receptor to the media provided to the transfer zone.

2. The printing apparatus of claim 1 wherein the continuous media supply unit includes a tension load roll and a vacuum roll drive adapted to reverse the direction of the media through the nip and resume the original direction in order to synchronize the transfer of images.

3. The printing apparatus of claim 1 wherein the synchronization of the transfer of images is in relation to the seam of the flexible belt.

4. The printing apparatus of claim 1 wherein the synchronization of the transfer of images is in relation to the printing of labels.

5. The printing apparatus of claim 1 wherein the transfer zone includes a stripper drive and a biased transfer roll engaging the charge receptor to form a nip.

6. The printing apparatus of claim 5 wherein the biased transfer roll moves into and away from the stripper drive to open and close the nip.

7. The printing apparatus of claim 2 wherein the vacuum roll drive controls the movement of the media to a fuser device.

8. The printing apparatus of claim 2 wherein the tension load roll maintains suitable pressure on the continuous media to adapt to direction changes.

9. The printing apparatus of claim 1 wherein the BTR roll is a soft foam roll producing a nip of 3-5 mm width for generating a transfer field and depositing a positive tacking charge to the backside of the paper.

10. In an electrostatographic printing apparatus, comprising a charge receptor; a transfer nip in contact with the charge receptor at a transfer zone, the transfer nip including a stripper drive and a BTR roll, a source of continuous media provided to the transfer zone, a method of systematic engagement and disengagement of the media in the transfer nip for synchronization of image transfer from the charge receptor to the media comprising the steps of:
recognizing a requirement for the transfer nip to disengage from the continuous media,
disengaging the continuous media from the nip, and
reengaging the media with the nip.

11. The method of claim 10 including the steps of altering the movement of the continuous media from a first direction to a reverse direction in response to the requirement and returning the movement of the continuous media to the first direction whereby the transfer of image from the charge receptor to the continuous media are in synchronization.

12. The method of claim 10 wherein the requirement is the recognition of a charge receptor seam.

13. The method of claim 10 wherein the BTR roll is a soft foam roll producing a nip of 3-5 mm width for generating a transfer field and depositing a positive tacking charge to the backside of the paper.

14. The method of claim 11 wherein the lead edge of the seam area has just passed the BTR field at the nip exit.

15. The method of claim 14 including the steps of disengaging the stripper drive and biased transfer roll from the charge receptor during passage of the seam and reengaging the stripper drive and biased transfer roll after passage of the seam.
